(19) United States
(12) Patent Application Publication
(10) Pub. No.: US 2024/0407398 A1
(43) Pub. Date: Dec. 12, 2024

(54) LARGE DONUT-SHAPED DRY KIBBLE FOR SMALL ADULT DOGS

(71) Applicant: Société des Produits Nestlé S.A., vevey (CH)

(72) Inventors: Julie Almant, Thennes (FR); Séverine Ligout, CAMON (FR); Arthur Simoni, St. Louis, MO (US); Pascale CAREL, St. Louis, MO (US); Julien BELAHBIB, Amiens (FR)

(73) Assignee: Société des Produits Nestlé S.A., vevey (CH)

(21) Appl. No.: 18/635,499

(22) Filed: Apr. 15, 2024

Related U.S. Application Data
(60) Provisional application No. 63/506,544, filed on Jun. 6, 2023.

(51) Int. Cl. A23K 50/42; A23K 40/00

(52) U.S. Cl. CPC A23K 50/42; A23K 40/00

(57) ABSTRACT

Methods for feeding small adult dogs include dispensing a serving of dry kibble to a small adult dog weighing less than about 11 kg, wherein from about 20% to 100% of individual dry kibble pieces of the serving can be donut-shaped and have an average inner-hole diameter from about 3 mm to about 8 mm and are about 8 mm to about 2 cm in average diameter. The dry kibble can also have an average thickness from about 8 mm to about 2 cm.

### CROSS REFERENCE TO RELATED APPLICATIONS

This application claims priority to U.S. Provisional Application Ser. No. 63/506,544 filed Jun. 6, 2023, the disclosure of which is incorporated in its entirety herein by this reference.

### BACKGROUND

Small adult dogs are often fed with dry kibble that is commensurate in size with the smaller volumes and constrained shapes that are common to the anatomy of the small adult dogs. For example, it is common to feed a small dog standard shaped kibble that is relatively small in size, such as cuboidal or rectangular pieces having an average size well below about 1 centimeter, e.g., about 6 mm length by width by thickness. Furthermore, there can may be various animal behaviors that can also contribute to feeding issues, such as rapid eating and rushed chewing, which in some instances can lead to labored swallowing. Behavioral studies can be carried out to determine if there may be sizes, shapes, thicknesses, and/or other configurations that would improve some of these negative behaviors to the benefit of the health of the animal.

### BRIEF DESCRIPTION OF THE DRAWINGS

FIG. 1 illustrates an example upper jaw and lower jaw of a canine or dog, showing example teeth position suitable for measuring and calculating the average oral cavity area of a canine in accordance with the present disclosure;

FIG. 2 is a box plot graph illustrating example data related to eating duration over a small adult dog population in accordance with the present disclosure;

FIG. 3 is a graph illustrating example eating duration modifications over a population of small adult dogs occurring by varying a single physical property, e.g. shape, diameter, or thickness, compared to a Reference Kibble in accordance with the present disclosure;

FIG. 4 is a box plot graph illustrating example data related to chewing duration over a small adult dog population in accordance with the present disclosure;

FIG. 5 is a graph illustrating example chewing duration modifications over a population of small adult dogs occurring by varying a single physical property, e.g. shape, diameter, or thickness, compared to a Reference Kibble in accordance with the present disclosure;

FIG. 6 is a box plot graph illustrating example data related to prehension over a small adult dog population in accordance with the present disclosure;

FIG. 7 is a graph illustrating example prehension modifications over a population of small adult dogs occurring by varying a single physical property, e.g. shape, diameter, or thickness, compared to a Reference Kibble in accordance with the present disclosure;

FIG. 8 is a graph illustrating example speed of eating modifications over a population of small adult dogs occurring by varying a single physical property, e.g. shape, diameter, or thickness, compared to a Reference Kibble in accordance with the present disclosure; and

FIG. 9 is a graph illustrating example labored swallowing modifications over a population of small adult dogs occurring by varying a single physical property, e.g. shape, diameter, or thickness, compared to a Reference Kibble in accordance with the present disclosure.

### DETAILED DESCRIPTION

In accordance with examples of the present disclosure, methods and compositions for feeding small adults dogs are disclosed. In some examples, methods of feeding small adult dogs can include dispensing a serving of dry kibble to a small adult dog weighing less than about 11 kg. In accordance with these methods, from about 20% to 100% of individual dry kibble pieces of the serving can be donut-shaped, having an average inner-hole diameter from about 3 mm to about 8 mm, an average diameter from about 8 mm to about 2 cm, and an average thickness from about 8 mm to about 2 cm. In one example, the average diameter can be from about 1.1 cm to about 2 cm and/or the average diameter can be from about 1.4 cm to about 2 cm or from about 1.1 cm to about 2 cm. In some examples, the dry kibble has a moisture content from about 4 wt % to about 10 wt % and/or the dry kibble has an average stiffness from about 40 N/mm to about 120 N/mm. In further detail, after dispensing the serving and the small adult dog begins feeding on the dry kibble, from about 45% to about 75% of the first three minutes of feeding on average can include chew time and/or less than 50% of the first three minutes of feeding on average includes prehension time. In other examples, the small adult dog can exhibit a lower frequency of labored swallowing during the first three minutes of feeding the dry kibble to the small adult dog as compared to the first three minutes of feeding the small adult dog a comparative dry kibble without an inner-hole therethrough and having about a smaller diameter and a smaller thickness compared to the dry kibble. In additional detail, the small adult dog can be not only defined by weight, but may also further be defined by the dog's average oral cavity area, which may be from about 12 cm² to about 22 cm², for example.

Other examples of dry kibble can include from about 20% to 100% donut-shaped dry kibble pieces having an average inner-hole diameter from about 3 mm to about 8 mm, an average diameter from about 1.1 cm to about 2 cm, and an average thickness from about 8 mm to about 2 cm. In these examples, the dry kibble can have an average stiffness from about 40 N/mm to about 120 N/mm and a moisture content up to about 10 wt %. In some examples, the dry kibble is formulated for small adult dogs and can be packaged with indicia indicating that the dry kibble is for small adult dogs. In further detail, the average diameter can be from about 1.4 cm to about 2 cm and/or from about 1.1 cm to about 2 cm.

It is noted that when discussing examples related to the methods of feeding small adult dogs or the dry kibble adapted for feeding small adult dogs, such discussions can be considered applicable to one another whether or not they are explicitly discussed in the context of that example. Thus, for example, when discussing “average inner-hole diameter” in the context of the methods, such disclosure is also relevant to and directly supported in the context of dry kibble, and vice versa.

Furthermore, terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

Reference to the term “kibble” refers to pieces of dry or semi-moist pet food which can have a pellet shape or any other shape. Non-limiting examples of kibbles include particulates; pellets; pieces of pet food, dehydrated meat, meat analog, vegetables, and combinations thereof; and pet snacks, such as meat or vegetable jerky, rawhide, and biscuits.

Reference here to the term “dry kibble” refers to a kibble(s) having a moisture content up to about 20 weight % (wt %) water content. In some examples, the water content can be up to about 15 wt %, up to about 12 wt %, or up to about 10 wt %. Example water content ranges can be from about 4 wt % to about 10 wt %, from about 5 wt % to about 9 wt %, or from about 7 wt % to about 9 wt %. Furthermore, the kibble can have a rheology that is distinguishable over that of moist or even semi-moist kibble. A method of determining rheology of kibble includes using a pointed probe that is tapered from a pointed tip to a diameter of about 5 mm over a tapering length of about 1.5 cm. To take the measurements, the tapered probe is forced to descend at its pointed end into the kibble at a constant speed, e.g., about 2 mm/sec. The probe may be set for a maximum penetration descent or distance into the kibble of up to about 4 mm (or greater), as breakage of dry kibble would typically occur prior to about 3 mm. Using this equipment, the penetration force in Newtons (N) and the distance until breakage in millimeters (mm) is then recorded, which can then be used to calculate a slope representing the stiffness in Newtons per millimeter (N/mm). In accordance with some examples of the present disclosure, the kibble of the present disclosure can have a stiffness from about 40 N/mm to about 120 N/mm, from about 50 N/mm to about 110 N/mm, or from about 60 N/mm to about 100 N/mm, which is considered to be dry and would typically exclude semi-moist or softer kibbles.

In accordance with examples of the present disclosure, the dry kibble includes at least about 20% individual dry donut-shaped kibble pieces. In some examples, the dry kibble can include from about 20% to 100% donut-shaped dry kibble, from about 35% to 100% donut-shaped dry kibble, from about 50% to 100% donut-shaped dry kibble, from about 75% to 100% donut-shaped dry kibble, from about 90% to 100% donut-shaped dry kibble, about 100% donut-shaped dry kibble, or from about 50 wt % to about 95 wt % dry kibble. Though the dry kibble of the present disclosure is donut-shaped (or predominantly donut-shaped), there are other dry kibble compositions described herein for comparative purposes used to evaluate chew time, labored swallowing, and/or other eating attributes associated with the feeding of small adult dogs.

The dry kibble can be prepared to include animal tissue (protein and fats), e.g., beef, chicken, turkey, pork, lamb, fish, beef tallow, rendered pork fat, chicken fat, turkey fat, lamb fat, fish fat, etc. In some examples, the dry kibble may alternatively or additionally include non-animal protein and fat sources and/or carbohydrates, e.g., green peas, chickpeas, beans, barley, oatmeal, brown rice, soy protein, pea protein, etc. The dry kibble may include an animal digest coated thereon or otherwise incorporated therein, such as dried animal digest or liquid animal digest. The dry kibble may likewise include ingredients such as antioxidant, palatability-enhancing compounds, nutrition-enhancing additives, etc. For example, an antioxidant(s) can be added at any stage during preparation to prevent oxidation that is often associated with the presence of fats. Examples of antioxidants that can be selected for use include natural or synthetic antioxidants, such as butylated hydroxyanisole, butylated hydroxytoluene, propyl gallate, octyl gallate, tocopherols, rosemary extract, ascorbic acid, or a combination thereof. Additionally, the dry kibble can optionally include additional ingredients, such as starches, humectants, oral care ingredients, preservatives, amino acids, fibers, prebiotics, sugars, animal oils, aromas, other oils additionally or alternatively to vegetable oil, salts, vitamins, minerals, probiotic microorganisms, bioactive molecules or combinations thereof. Non-limiting examples of suitable preservatives include potassium sorbate, sorbic acid, sodium methyl para-hydroxybenzoate, calcium propionate, propionic acid, and combinations thereof.

In accordance with examples of the present disclosure, the donut-shaped dry kibble described herein can have any of a number of dimensional ranges. As mentioned, the dry kibble can have an average diameter from about 8 mm to about 2 cm, but other diameter dimensions may be from about 1 cm to about 2 cm, from about 1.1 cm to about 2 cm, from about 1.1 cm to about 1.8 cm, or from about 1.4 cm to about 2 cm, for example. The average thickness of the dry kibble can be from about 8 mm to about 2 cm, from about 1 cm to about 2 cm, from about 1.1 cm to about 2 cm, from about 1.1 cm to about 1.8 cm, or from about 1.4 cm to about 2 cm, for example. The inner hole can have an average size from about 3 mm to about 8 mm, from about 3 mm to about 6 mm, from about 4 mm to about 7 mm, or from about 4 mm to about 6 mm, for example.

In referring to “diameter” herein, this does not necessarily infer that the dry kibble is round or that the inner-hole of the dry kibble is round or perfectly circular per se, as there may be some variation in the generally arcuate nature of individual dry kibble pieces with respect to the outer shape and the shape of the inner-hole therein. Furthermore, the inner-hole may or may not be completely concentric with respect to the outer “diameter” of the individual dry kibble pieces, as the inner-hole may be slightly offset with respect to its location relative to the outer perimeter of the dry kibble. When the dry kibble does not have a substantially or fully circular outer perimeter shape and/or inner-hole shape, the “diameter” is based on its “equivalent diameter,” which is based on a distance measurement around the perimeter shape and/or inner-hole shape of the dry kibble. That distance measurement is then assumed to be the circumference of an equivalent circle for determining the equivalent diameter of the dry kibble. Thus, the term “diameter” as used herein is also inclusive of shapes that may not be perfectly circular at the perimeter or inner-hole, but which can be measured and idealized as being circular to determine its equivalent diameter (or as defined herein, as its “diameter”). Furthermore, when considering the “diameter” of comparative dry kibble shapes, such as squares, pentagons, etc., the diameter of those kibbles can be calculated in the same manner to determine an “effective diameter.” Sometimes the diameter may be referred to as the “size” for further clarity, but either way, this measurement is based on either the diameter or the equivalent diameter (if not a circle) in the X-Y plane of the dry kibble.

The terms “thickness” or “thick” refer to the measurement of the dry kibble in the Z axis direction, which is perpendicular to the diameter measurement of the dry kibble. As the dry kibble of the present disclosure is donut-shaped, it is understood that the thickness or Z axis measurement is perpendicular to the X-Y planar dimension having the inner-hole therethrough.

The term “donut-shaped” as used herein includes any shaped dry kibble with X-Y axes having an outer perimeter and a Z axis thickness. The X-Y axes also include an inner-hole passing through the dry kibble. The inner-hole may be concentrically positioned relative to the outer perimeter or may be offset relative to the outer perimeter. The size of the outer perimeter and the inner-hole are measured based on their diameter, which is the equivalent diameter measurement when the dry kibble is not circular, e.g., oval or some other similarly rounded shape.

When referring to small adult dogs, there is not a clear weight cutoff that is agreed to universally, so for purposes of the present disclosure, the small adult dogs can range in size from the smallest domesticated adult dogs to small dogs up to about 10 kg. The small adult dogs may typically be domesticated dogs that are no longer puppies, e.g., at least 1 year old. In some examples, small dogs include all dogs up to about 11 kg, up to about 10.5 kg, up to about 10 kg, or up to about 9 kg, for example. In some examples, however, the dry kibble described herein can be prepared for dogs ranging from about 3 kg to about 11 kg, from about 3 kg to about 10 kg, from about 3 kg to about 9 kg, from about 4 kg to about 10.5 kg, from about 4 kg to about 10 kg, from about 4 kg to about 8 kg, from about 5 kg to about 10 kg, or from about 6 kg to 11 kg. In further detail, small adult dogs can be further classified by their mouth

size. This can be particularly useful with respect to the presently disclosed methods and compositions, because the diameters and thicknesses of the dry kibble of the present disclosure are rather large by comparison to the mouth size of small adult dogs. Mouth size of dogs can be measured and then a subsequent calculation can be carried out to return a single value referred to herein as the “average oral cavity area.” Notably, this measurement does not include a Z axis measurement (as would be used to determine mouth volume), as the average oral cavity area is sufficient for defining general mouth sizes for small adult dogs in accordance with the present disclosure.

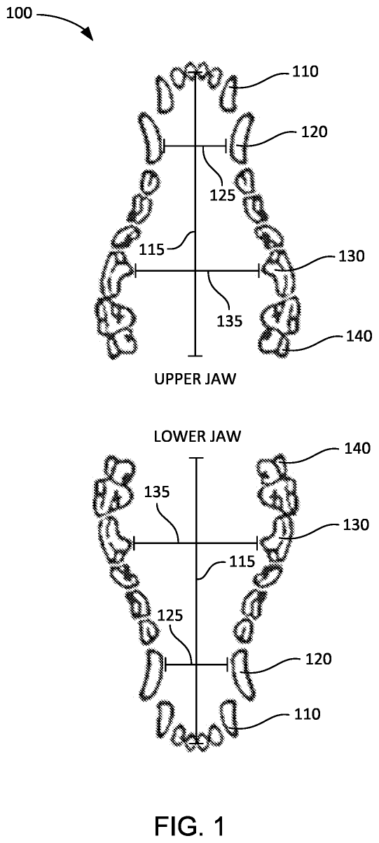

In accordance with examples of the present disclosure, the average oral cavity area for a dog can range from about 12 cm² to about 22 cm², from about 14 cm² to about 21 cm², from about 15 cm² to about 20 cm², or from about 14 cm² to about 18 cm², for example. To calculate the average oral cavity area of a dog, measurements are carried out independently for the upper jaw and the lower jaws. The location of the measurements are provided at FIG. 1 where example upper and lower jaws 100 are illustrated. The measurement is taken for each jaw separately, such as by independently measuring the jaw lengths 115, which is the distance that extends from the front of the third incisor 110 to the back of the mouth aligned with the back of the last molar 140. The upper and lower jaws are also independently measured for canine width 125, which is defined as the distance between the right and left canines 120. Molar width 135 is also measured for each of the upper and lower jaws, which is defined as the distance between the right and left carnassian molars 130. For each jaw measurement, an average width is determined by averaging the canine width and the molar width. The area of each jaw is then determined by multiplying the average width by the jaw length. To obtain the “average oral cavity area” as defined herein, the upper jaw area and the lower jaw area are averaged together, in accordance with the following formulas:

$$Upper Jaw \text{} Area = [ \text{} ( Upper Canine Width + Upper Molar Width ) / 2 ] \times Upper Jaw Length$$

$$Lower Jaw Area = [ \text{} ( Lower Canine Width + Lower Molar Width ) / 2 ] \times Lower Jaw Length$$

$$Average Oral Cavity Area = [ Upper Jaw Area + Lower Jaw Area ] / 2$$

By feeding small adult dogs with the donut-shaped dry kibble described herein, even though the diameter of the dry kibble is relatively large, it was unexpected that by increasing the size (diameter) of the outer dimensions of the dry kibble and/or introducing an inner hole through otherwise solid kibble shapes, e.g., round becomes a donut shape, these two modifications independently (and in some instances additively) promoted multiple behavioral benefits associated with the feeding of small adult dogs. For example, by introducing a donut-shaped kibble, good behaviors occurred trending toward promoting lengthening of eating duration, increased chewing time, reduced prehension time, and reduced speed of eating. Furthermore, it was found that larger dry kibble diameters tended to also increase chewing time, reduce prehension time, and reduce labored swallowing. Thus, both donut shape and increased diameter of dry kibble promoted increased chewing time and reduced prehension.

Prehension relates to a behavior where the small adult dog is interactive with the dry kibble in the bowl or on the floor, i.e. collecting the food for chewing and/or swallowing. For example, prehension includes the grasping and manipulation of food and is generally achieved with the use of the tongue, teeth, and mandible in keeping the dry kibble and fluids in the oral cavity. As increasing the chewing time slows down the speed of eating and increases the meal duration, an increase in prehension time, on the other hand, tends to indicate interaction with food in ways that do not include chewing and swallowing. Essentially, a dog should ideally spend less time collecting and holding food in the mouth and more time chewing the food for better digestion. In some instances, decreasing prehension time can be considered a positive behavior modification, and in some instances, increased prehension can be positive if the dog's speed of eating is too rapid, for example.

There is a correlation between slower eating behaviors with adequate chewing as it relates to good animal digestion. Thus, by slowing the speed of eating, lengthening the total meal duration, and increasing the chewing time, better digestion can be realized. Furthermore, by reducing the occurrences of labored swallowing (which may typically follow slower eating and increased chewing), animal safety can be increased. All of these behavior changes can lead to better eating habits of small adult dogs. As an example, it can be seen in the data of the Examples below that donut-shaped larger dry kibble (1.6 cm diameter) can significantly increase chewing time, which is linked strongly to oral care, digestion, and satiety. Contrarily, small kibble size (5 mm diameter), with either a solid or donut-shape, tended to reduce chewing time and significantly increase the occurrence of labored swallowing that might be perceived as an early indicator of a safety concern by the owners. This information can be extended to all small adult dogs, which may include even small toy dogs, such as Chihuahuas, for example.

### Definitions

As used herein, “comprising” or “including” language or other open-ended language can be substituted with “consisting essentially of” and “consisting of” as if such transition phrase is expressly included in such embodiments.

The term “average” when referring to a size dimension of dry kibble relates to a plurality of pieces that are collected together in a common sample and averaged over the sample.

The term “about” refers to values similar to specifically enumerated numbers with some flexibility that would not substantially alter the function of the benefit achieved by the value(s) provided. For example, the term “about” can refer to the recited number plus or minus 5%, plus or minus 3%, or plus or minus 1%. To illustrate, the term “about” when interpreted as being plus or minus 5% of a numeric range, such as “from about 1 cm to about 2 cm,” would be interpreted as including a range from 9.5 mm to 2.1 cm, from 1.05 cm to 1.9 cm, from 9.5 mm to 1.9 cm, or 1.05 cm to 2.1 cm. Similar calculations for any of the other individual numerical values or individual parameters of numerical ranges set forth herein can be modified similarly such that the “about” modifier fully supports subranges including +/−3% or +/−1% of the numerical value provided.

As used herein, ranges are in shorthand so as to avoid having to list and describe each and every value within the range. Any appropriate value within the range can be selected, where appropriate, as the upper value, lower value, or the terminus of the range, and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting one numerical value. Furthermore, such an interpretation should apply regardless of the breadth of the range or the characteristics being described.

The term “example(s)” or “embodiment(s),” such as when followed by a listing of terms or when giving a specific illustration including details of a single or multiple parameters is merely illustrative and should not be deemed to be exclusive or comprehensive.

The methods and compositions disclosed herein are not limited to particular methodology, protocols, reagents, etc., described herein because, as the skilled artisan will appreciate, they may vary. Further, the terminology used herein is for the purpose of describing particular embodiments only, and is not intended to and does not limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, certain compositions, methods, articles of manufacture, or other means or materials are described herein.

As used herein, a plurality of elements, compositional components, and/or materials may be presented in a common list for convenience. However, these lists should be construed as though individual members of the list are individually identified as separate and unique members. Thus, no individual member of such list should be construed as a de facto equivalent of any other member of the same list solely based on presentation in a common group without indications to the contrary.

### EXAMPLES

Features of the present disclosure can be further illustrated by the following examples, although it will be understood that these examples are included merely for purposes of illustration and are not intended to limit the scope of the invention unless otherwise specifically indicated.

### Example 1—Small Adult Dog Monadic Feeding Behavior Study

Several small adult dogs of various breeds were studied to evaluate their feeding behavior as it related to many different dry kibble shapes and sizes. Initially, there were 8 females and 12 males split into two 10 dog panels (Panel 1 and Panel 2), but one male dog from Panel 1 was excluded for his outstanding feeding behavior, e.g., no meaningful data would be collectable related to discriminating dry kibble shape and size. The 19 remaining small adult dogs ranged from 6.78 kg to 10.48 kg in size with calculated ages ranging from about 1.3 years to 6.96 years. The identity of the small adult dogs in Panel 1 and Panel 2 are identified in Tables 1A and 1B, respectively:

TABLE 1A
Panel 1 Small Adult Dogs

| Breed ID | Gender | Weight | Calculated Age |
|---|---|---|---|
| Cairn Terrier 1 | F | 6.78 kg | 1.46 yrs |
| Cairn Terrier 2 | M | 9.52 kg | 2.24 yrs |
| Cairn Terrier 3 | F | 7.64 kg | 2.08 yrs |
| Cairn Terrier 4 | M | 8.74 kg | 1.3 yrs |
| Schipperke 1 | F | 7.00 kg | 3.72 yrs |
| Schipperke 2 | M | 6.96 kg | 3.72 yrs |
| Cairn Terrier 5 | M | 8.56 kg | 2.08 yrs |
| Cairn Terrier 6 | F | 8.16 kg | 1.6 yrs |
| Cavalier King Charles 1 | M | 9.06 kg | 6.48 yrs |

*One (1) Cairn Terrier (M; 8.16 kg; 2.12 yrs) was excluded from Panel 1 of the study for outstanding feeding behavior

TABLE 1B
Panel 2 Small Adult Dogs

| Breed ID | Gender | Weight | Calculated Age |
|---|---|---|---|
| Cairn Terrier 7 | F | 8.12 kg | 2.14 yrs |
| Miniature Schnauzer 1 | M | 7.72 kg | 4.48 yrs |
| Border Terrier 1 | M | 9.28 kg | 2.12 yrs |
| Cavalier King Charles 2 | M | 10.48 kg | 5.55 yrs |
| Smooth Fox Terrier | F | 7.38 kg | 4.59 yrs |
| Cavalier King Charles 3 | F | 7.9 kg | 4.94 yrs |
| Miniature Schnauzer 2 | M | 7.56 kg | 2.65 yrs |
| Cairn Terrier 8 | M | 9.02 kg | 2.08 yrs |
| Cavalier King Charles 4 | M | 9.4 kg | 4.94 yrs |
| Cairn Terrier 9 | F | 7.28 kg | 6.96 yrs |

In this study, Monadic feeding behaviors were observed. The dogs were fed only one product at a time under a controlled feeding plan and acceptance was analyzed using video observation and statistical analysis. The Design of Experiment (DoE) was defined to evaluate the feeding behavior based on kibble shape, kibble size, and kibble volume. More specifically, 16 different dry kibbles of the same Dog Chow recipe were prepared, each having its own unique physical dimension based on four different shapes, three different diameters (or effective diameter) based on the X-Y plane, and three different thicknesses along the Z axis perpendicular to the X-Y plane, with diameters, shapes, thicknesses, and Sample #s shown in Table 2:

TABLE 2
Dry Shapes and Dimensions

| | | SHAPE | | | | | | | | | | | |
|---|---|---|---|---|---|---|---|---|---|---|---|---|---|
| SIZE | | Thickness & Dry Kibble Sample # | | | | | | | | | | | |
| (EFFECTIVE | | PENTAGON | | | ROUND | | | SQUARE | | | DONUT | | |
| DIAMETER) | | [symbol] | | | [symbol] | | | [symbol] | | | [symbol] | | |
| 5 | mm | 4 | mm | #1 | 8 | mm | #5 | 1.2 | cm | #9 | 8 | mm | #13 |
| 1 | cm | 1.2 | cm | #2 | 8 | mm | #6 | 4 | mm | #10 | 8 | mm | #14 |
| 1 | cm | 8 | mm | #3 | 1.2 | cm | #7 | 8 | mm | #11 | 4 | mm | #15 |
| 1.6 | cm | 8 | mm | #4 | 4 | mm | #8 | 8 | mm | #12 | 1.2 | cm | #16 |

Before any data was collected, the dogs were made accustomed to the environment and the transparent feeding bowls during a 3 day habituation period. Notably, after three days of using the transparent bowls, it was observed that any behavior associated with the transparent bowls initially subsided. The data was then collected by Monadic feeding and behavior video recording with one (1) day of feeding per variable. The order of the variables was selected at random within the panel and between panels. The dogs were tested each day in the same order to keep the time period between feedings constant for every dog, and the testing period occurred during the main meal time of the day for the dogs, namely from 7:30 am to 8:30 am daily. The main meal of the Dog Chow recipe at the testing time was provided at a fixed amount. On days that the dog(s) were not being tested, the dogs received medium palatability dry kibble (no more than 7 days) to prevent overexposure to the Dog Chow recipe being used for the study.

Multiple video cameras were mounted to record the dogs during the study. Based on 16 variables of dry food kibble shown in Table 1 and a total of 19 small adult dogs (with the one dog excluded), a total of 304 videos were collected. The main meal during the testing period was edited to show only the first three minutes of feeding, and a third party was enlisted for behavioral coding using Behavioral Observation Research Interactive Software (BORIS).

Feeding behaviors measured (Ethogram) relating to easiness of eating, chewing behavior, food enjoyment, and others were coded and included the following behaviors in Table 3 as follows:

TABLE 3
Small Adult Dog Feeding Behaviors

| Parameter | Unit/Category | Description |
|---|---|---|
| Meal duration | Duration (s) | Duration from first lick/bite until last swallow/lick/not |
| | | returning to bowl within 2 mins after leaving |
| Speed of | Duration (s) | Time of meal is finished <3 mins; noted as maximum |
| eating | | duration time if greater than 3 mins |
| Nose in bowl | Duration (s) | Time spent with nose “in the bowl” (from the level of the |
| | | bowl rim to the top of the kibble) |
| Kibbles falling | Count (#) | Number of kibble pieces unintentionally falling from |
| from mouth | | mouth after a bite or mouthful or chewing (but not while |
| | | mouth or tongue are in contact with the kibble in the bowl) |
| Prehension | Duration (s) | Clear large bites or jaw movements or licks with mouth or |
| duration | | tongue in contact with kibble in the bowl or on the floor |
| Chewing | Duration (s) | Visible jaw movements aiming at breaking kibbles with |
| duration | | any head position, but not while mouth our tongue are in |
| | | contact with kibble in the bowl or on the floor |
| Labored | Count (#) | Visible difficulty to swallow food showed by chin thrust at |
| swallow | | any time, including while nose is in bowl or head is raised, |
| | | followed by an obvious deglutition (viewed at full speed |
| | | without slowing video) |
| Food | Count (#) | Fast back and forth (or slightly lateral) head movement to |
| repositioning | | rapidly reposition/move kibbles in mouth after mouthful |
| | | taken, usually associated with opening of the mouth while |
| | | head is out of the bowl or on the floor. |

### Example 2—Small Adult Dog Feeding Behavior Observations

A statistical analysis was carried out on the collected data. It is notable that the percent (%) of time spent chewing followed a normal distribution, while other behaviors did not. In addition to the percent of time spent chewing, Box-cox transformations were successfully used to obtain a normal distribution of the following behavior: Meal duration (X^{0.6353}), percent (%) of time spent with nose in the bowl (x^{0.0002913}), percent (%) of prehension time or dog interacting with the food (x^{0.001224}), and frequency of food repositioning (x^{9.816e-21}). These behaviors that followed normal distributions or could be transformed to follow a normal distribution were tested for differences induced by the product using a Variance Analysis (ANOVA). Behaviors could also be evaluated using the Tukey Honest Significant Differences test (Tukey's test). Furthermore, behaviors not following a normal distribution were statistically tested using non-parametric tests, namely Kruskal-Wallis' test to analyze variance and Dunn's test for pairwise comparisons.

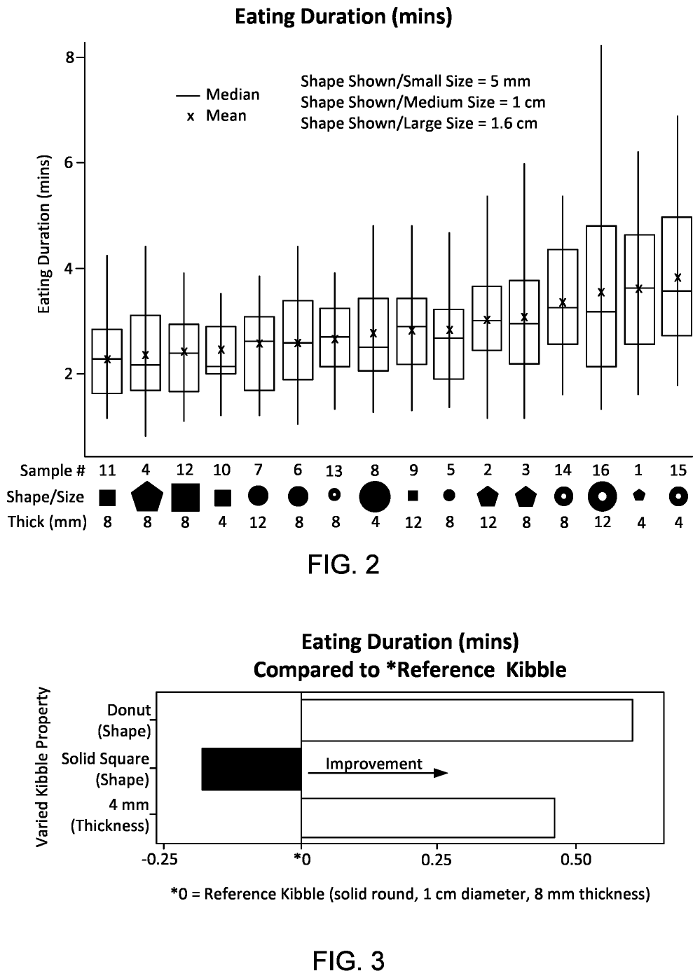

More specifically, the graphs shown at FIGS. 2, 4, and 6 show the raw behavioral data collected for Eating Duration, Chewing Duration, and Prehension, respectively. In particular, these three boxplot graphs illustrate an animal feeding behavior along the y axis of the graph, and the x axis of the graph includes three lines of dry kibble identifying information. In each instance, there are sixteen (16) different dry kibble samples plotted along the x axis of the boxplot graph, which are notated as “Sample #” along the first line of identifying information. The second line of identifying information illustrates (i) dry kibble shape and (ii) dry kibble outer dimensional size (equivalent diameter) along its X-Y plane, e.g., small icons illustrating a 5 mm size, medium icons illustrating a 1 cm size, and large icons illustrating a 1.6 cm size. The third line of identifying information provides the dry kibble thickness along its Z axis (perpendicular to the outer dimensional size). All of the sizes are based on the average sizes of the sample of dry kibble given to the small adult dogs during the study. Other than those differences shown along the x axis of the boxplot graph, all of the other dry kibble features were otherwise the same, such as dry kibble compositions, textures, etc. Furthermore, for each of the boxplots of FIGS. 2, 4, and 6, the median value for each sample is shown as a horizontal line within the boxplot, and the mean value is shown as an “x” also within the box. Furthermore, the box represents the middle 50% of the population of small adult dogs, i.e. 25% of the population fell below the represented box values and 25% of the population were above the represented box values illustrated. The vertical line represents the middle 80% of the population of small adult dogs, i.e. 10% of the population fell below the represented vertical line values and 10% of the population were above the represented vertical line values illustrated.

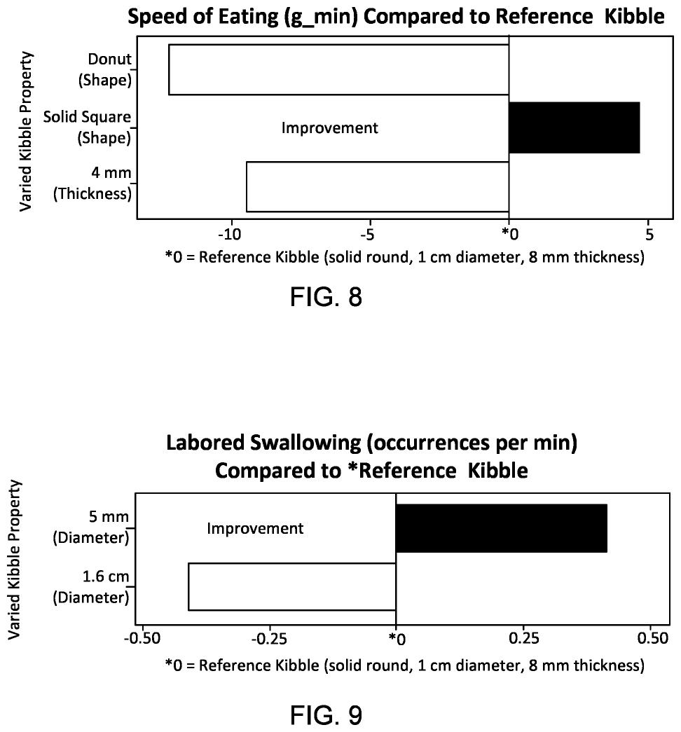

An alternative graph of the raw data is presented in FIGS. 3, 5, and 7-9. The data collected showed statistical differences (including transformed data where applicable) when a single modification was made to the outer dimensional size (X-Y plane), shape, or thickness (Z-axis) relative to a consistently prepared reference kibble sample, referred to as “Reference Kibble.” The Reference Kibble used in this study was solid round in shape, 1 cm in outer dimensional diameter, and had an 8 mm thickness, i.e. Sample #6 as shown in FIGS. 2, 4, and 6. In each of these graphs, the Reference Kibble provided reference data that is shown along a line notated at *0. The Reference Kibble was then compared against various single-parameter variations to determine which individual kibble variables would provide a positive impact on small dog behavior. This single-parameter modification was plotted as positively impacting the behavior (shown as white bars) or negatively impacting the behavior (shown as black bars). For example, FIG. 3 illustrates data plotted against the Reference Kibble for Eating Duration, FIG. 5 illustrates data plotted against the Reference Kibble for Chewing Duration, and FIG. 7 illustrates data plotted against the Reference Kibble for Prehension. These three graphs may be compared to the data collected from the separate study described with respect to FIGS. 2, 4, and 6, respectively. Furthermore, there are two additional graphs provided in this study, including that shown in FIG. 8 illustrating data plotted against the Reference Kibble for Speed of Eating and FIG. 9 illustrating data plotted against the Reference Kibble for Labored Swallowing.

In further detail, it is noted that the data collected included a variance analysis (ANOVA) related to various behaviors to provide a normal distribution of data, which showed a significant effect of certain variables related to eating duration (time; transformed), proportion of time spent chewing (% of meal duration), and proportion of time spent interacting with the food (prehension; % or meal duration; transformed), as outlined in greater detail in studies A-E below.

### A. Eating Duration

As shown in FIG. 2, eating duration was plotted for all of the small adult dogs against the sixteen (16) different dry kibble samples. In this example, the small adult dogs collectively spent more mean time eating the dry kibble of Sample 15 than all of the other samples, and more median time eating than all but one of the other samples, with the dry kibble of Samples 4, 11, or 12 performing the worst. Notably, three of the top four performing dry kibble samples were donut-shaped, i.e. two medium size and one large size.

As can be seen by FIG. 3, in evaluating donut shaped kibble, solid square shaped kibble (no inner-hole), and 4 mm (thin) kibble variables independently against the Reference Kibble, the most significant eating duration improvement, i.e. slowing of duration, was seen with respect to the donut shaped kibble modification. Modification to a thinner kibble also performed better than the reference kibble. However, moving from a solid round shape to a solid square shape resulted in a slight decline in duration of eating.

### B. Chewing Duration

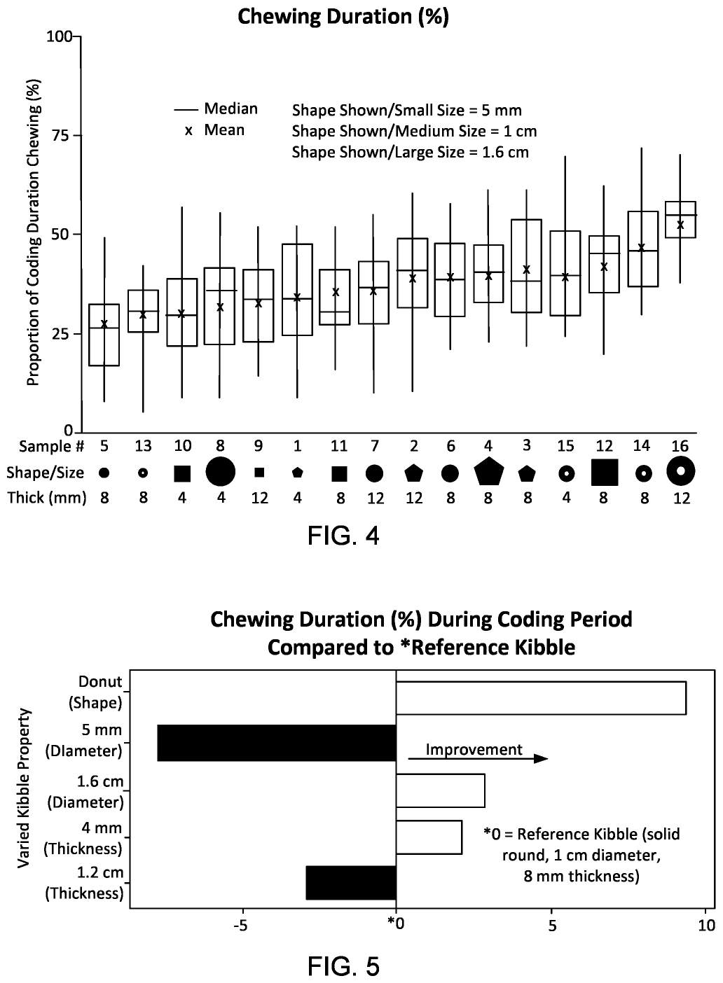

As shown in FIG. 4, chewing duration was plotted for all of the small adult dogs against the sixteen (16) different dry kibble samples. In this example, the small adult dogs collectively spent considerably more mean time and median time chewing Sample 16 during the first three minutes of feeding than all of the other samples by a considerable margin. Sample 16 was a donut-shaped kibble that had the largest diameter (1.6 cm) and thickness (1.2 cm). In most instances, the very small kibble sizes (based on diameter or equivalent diameter) generally performed the worst. Notably, again three of the top four performing dry kibble samples were donut-shaped, i.e. two medium size and one large size, with the largest sized donut-shaped kibble by every metric being the best.

As can be seen by FIG. 5, in evaluating modification of the shape to donut-shaped kibble, modification of diameter (either smaller or larger), and modification of thickness (either thinner or thicker) against the Reference Kibble, the most significant chewing duration improvement, i.e. increased chewing time over the first three minutes of feeding, was seen with respect to modification of the round kibble to a donut-shaped kibble. Furthermore, modification to a larger diameter also performed better than the Reference Kibble. Some improvement was also seen by reducing the thickness of the kibble compared to the Reference Kibble. The biggest decline in behavior occurred by reducing the diameter of the kibble relative to the Reference Kibble.

### C. Prehension

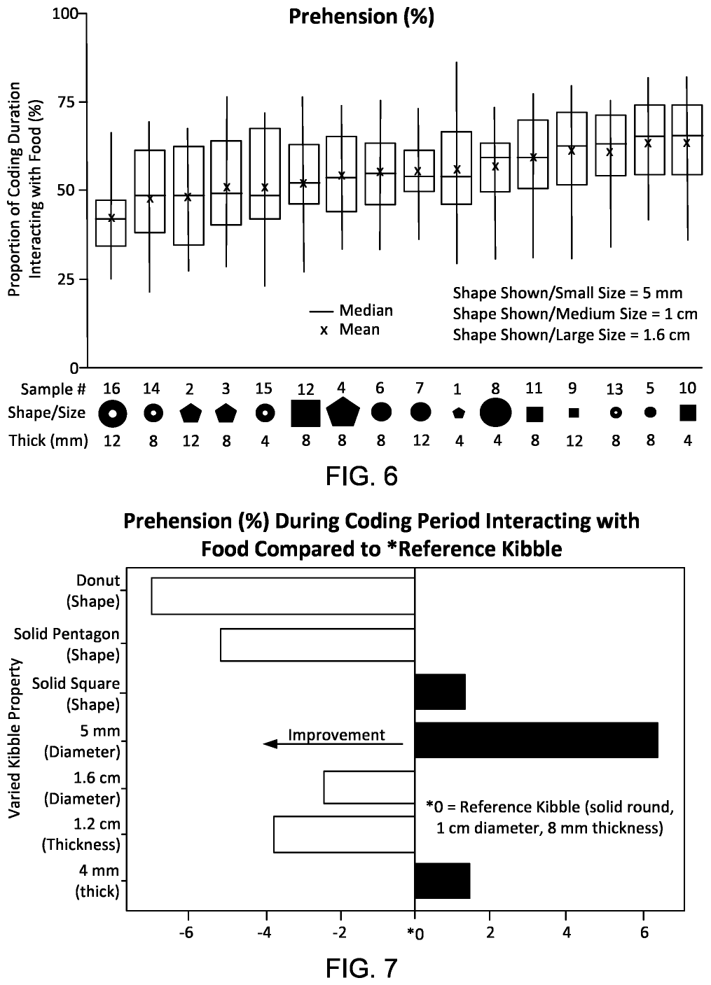

As shown in FIG. 6, prehension was plotted for all of the small adult dogs against the sixteen (16) different dry kibble samples. In this example, the small adult dogs collectively spent considerably less prehension mean time and median time interacting with Sample 16 by a considerable margin compared to all of the other dry kibble samples. Again, Sample 16 was a donut-shaped kibble that had the largest diameter (1.6 cm) and thickness (1.2 cm). In most instances, the very small kibble sizes (based on diameter or equivalent diameter) generally performed the worst. In this example, three of the top five performing dry kibble samples were donut-shaped, i.e. two medium size and one large size.

As can be seen by FIG. 7, in evaluating single-parameter modifications to shape (either donut or solid pentagon), diameter (either 5 mm or 1.6 cm), or thickness (either 1.2 cm or 4 mm) against the Reference Kibble, the most significant prehension duration improvement, i.e. decreased prehension time, was seen with respect to modification of the round kibble to a donut-shaped kibble, though the solid pentagon shape was also better than the round shape. With respect to diameter and thickness modification, prehension was improved when both of those were increased compared to the Reference Kibble. Again, the biggest decline in behavior, i.e. increased prehension time, occurred by reducing the diameter of the kibble relative to the Reference Kibble.

### D. Speed of Eating

As shown in FIG. 8, in evaluating single-parameter modifications to shape (either donut or solid square) or thickness (4 mm) against the Reference Kibble, the most significant reduction in the speed of eating was seen with respect to modification of the round kibble to a donut-shaped kibble. The speed of eating was also decreased when the Reference Kibble was modified to reduce its thickness. Switching from a solid round shape to a solid square shape provided a decline in favorable behavior by promoting an increase in the speed of eating compared to the Reference Kibble.

### E. Labored Swallowing

As shown in FIG. 9, in evaluating single-parameter modifications to diameter (either 5 mm or 1.6 cm) against the Reference Kibble, a clear improvement was seen with respect to a reduction in labored swallowing by increasing the diameter of the kibble to 1.6 cm from the 1 cm diameter of the Reference Kibble. Reducing labored swallowing is beneficial as it can be an early indicator of dogs having more significant difficulty swallowing or even choking. Reducing the diameter to 5 mm lead to a significantly increased instance of labored swallowing, particularly when compared to the improvement found with the 1.6 cm diameter kibble. This study did not compare the solid round shape to the donut-shaped kibble, but it is clear from all of the preceding examples that the donut-shaped kibble provides improvement in many other behaviors outlined in this example. It is expected that a donut-shaped kibble would not detract from the reduced occurrences of labored swallowing, particularly if the donut-shaped kibble was of about the same size as the large diameter kibble evaluated for labored swallowing.

F. Frequency of Kibble Falling from the Mouth

Though the data is not presented here specifically, it was observed that kibble having a larger diameter (or effective diameter) tended to promote less food falling from the mouth during feeding.

### Example 3—Oral Cavity Size and Feeding Behavior

The first eight (8) dogs from Panel 2 as well as four (4) additional dogs from neither panel (but were similar in breed, gender, and weight as other dogs in the study) were further evaluated based on the size of their oral cavities. Dog mouth sizes can be measured without anesthesia, or more conveniently when under anesthesia such as when the dogs may otherwise be receiving a teeth cleaning by a veterinarian. To avoid the need for a more invasive MRI or other similar imaging process, this measurement and calculation as outlined herein provides a simple way of non-obtrusively determining the general size of a living dog's oral cavity that could be conducted easily by a qualified veterinarian, and provides a good approximation of the average area of a dog's oral cavity, as explained in connection with FIG. 1 previously. The measurements and calculations were carried out for all twelve (12) dogs and the data is reported in Table 4, as follows:

TABLE 4
Upper and Lower Jaw Dimensions and Calculated Average Oral Cavity Areas

| | UPPER JAW | LOWER JAW | | |
|---|---|---|---|---|
| | (a) Jaw Length | (a) Jaw Length | | |
| Breed ID | (b) Canine Width | (b) Canine Width | i. Upper Jaw Area | Average Oral |
| (weight) | (c) Molar Width | (c) Molar Width | ii. Lower Jaw Area | Cavity Area |
| Cairn Terrier 7 | (a) 65.75 mm | (a) 65.98 mm | i. 19.12 cm² | 16.375 cm² |
| (8.12 kg) | (b) 21.05 mm | (b) 14.3 mm | ii. 13.63 cm² | |
| | (c) 37.12 mm | (c) 27.01 mm | | |
| Miniature | (a) 75.0 mm | (a) 79.0 mm | i. 22.31 cm² | 19.675 cm² |
| Schnauzer 1 | (b) 21.0 mm | (b) 15.1 mm | ii. 17.22 cm² | |
| (7.72 kg) | (c) 38.5 mm | (c) 28.5 mm | | |
| Border | (a) 74.0 mm | (a) 69.17 mm | i. 26.23 cm² | 21.315 cm² |
| Terrier 1 | (b) 23.12 mm | (b) 16.28 mm | ii. 16.40 cm² | |
| (9.28 kg) | (c) 47.76 mm | (c) 31.13 mm | | |
| Cavalier King | (a) 52.0 mm | (a) 61.0 mm | i. 18.59 cm² | 17.345 cm² |
| Charles 2 | (b) 25.1 mm | (b) 17.1 mm | ii. 16.10 cm² | |
| (10.48 kg) | (c) 46.4 mm | (c) 35.7 mm | | |
| Smooth Fox | (a) 81.4 mm | (a) 85.0 mm | i. 2.057 cm² | 17.770 cm² |
| Terrier | (b) 19.03 mm | (b) 12.72 mm | ii. 14.97 cm² | |
| (7.38 kg) | (c) 31.52 mm | (c) 22.5 mm | | |
| Cavalier King | (a) 56.8 mm | (a) 55.4 mm | i. 19.34 cm² | 16.455 cm² |
| Charles 3 | (b) 25.0 mm | (b) 16.5 mm | ii. 13.57 cm² | |
| (7.9 kg) | (c) 43.1 | (c) 32.5 mm | | |
| Miniature | (a) 72.0 mm | (a) 73.0 mm | i. 18.76 cm² | 16.660 cm² |
| Schnauzer 2 | (b) 21.0 mm | (b) 14.3 mm | ii. 14.56 cm² | |
| (7.56 kg) | (c) 37.1 mm | (c) 25.6 mm | | |
| Cairn | (a) 76.9 mm | (a) 78.3 mm | i. 24.98 cm² | 21.305 cm² |
| Terrier 8 | (b) 21.8 mm | (b) 15.32 mm | ii. 17.63 cm² | |
| (9.02 kg) | (c) 43.17 mm | (c) 29.7 mm | | |
| *Cairn | (a) 69.5 mm | (a) 70.36 mm | i. 21.85 cm² | 19.145 cm² |
| Terrier 9 | (b) 20.87 mm | (b) 13.7 mm | ii. 16.44 cm² | |
| (9 kg) | (c) 42.0 mm | (c) 33.02 mm | | |
| *Cairn | (a) 72.8 mm | (a) 74.5 mm | 23.33 cm² | 19.69 cm² |
| Terrier 10 | (b) 20.6 mm | (b) 14.1 mm | 16.05 cm² | |
| (8.6 kg) | (c) 43.5 mm | (c) 29 mm | | |
| *Cairn | (a) 67.2 mm | (a) 69.3 mm | 20.40 cm² | 18.43 cm² |
| Terrier 11 | (b) 22.9 mm | (b) 15.8 mm | 16.46 cm² | |
| (9.3 kg) | (c) 37.81 mm | (c) 31.7 mm | | |
| *Cairn | (a) 72.5 mm | (a) 77.7 mm | 24.94 cm² | 21.64 cm² |
| Terrier 12 | (b) 23.2 mm | (b) 16.2 mm | 18.34 cm² | |
| (8.6 kg) | (c) 45.6 mm | (c) 31.0 mm | | |

*Not Part of Panel 1 or Panel 2 Small Adult Dogs

Based on this data, the average oral cavity area that was measured and calculated ranged from around 16 cm² to about 22 cm², however, there are smaller dogs with smaller oral cavities that would be categorized as small adult dogs and would be expected to exhibit similar behaviors with respect to some or all of: slower eating duration and speed, increased chewing and reduced prehension, as well as reduced labored swallowing.

Furthermore, in looking at the individual dog data, it was surprising that some of the dogs of various breeds with the smallest average oral cavity areas tested still performed positively with respect to some of these behaviors. For example, Cairn Terrier 7 (8.12 kg; 16.375 cm²) showed positive eating behavior with respect to chewing duration, eating duration, labored swallowing, and prehension; Cavalier King Charles 3 (7.9 kg; 16.455 cm²) showed positive eating behavior with respect to chewing duration, speed of eating, and prehension; Miniature Schnauzer 2 (7.56 kg; 16.660 cm²) showed positive eating behavior with respect to chewing duration, speed of eating, labored swallowing, and prehension; and Smooth Fox Terrier (7.38 kg; 17.770 cm²) showed positive eating behavior with respect to chewing duration, speed of eating, and prehension. Notably, Smooth Fox Terrier never showed labored swallowing, regardless of the kibble given. Thus, small adult dogs that are even as small as from about 3 kg to about 9 kg benefited from some to all of the kibble properties of the present disclosure with respect to behaviors in some or all of these categories.

### Example 4—Kibble Rheology

Multiple samples of dry kibble having less than about 10 wt % water content were evaluated for rheology compared to a semi-moist kibble sample having a moisture content significantly greater than about 10 wt %. Rheology of the kibble can be determined using a pointed probe that is tapered from a pointed tip to a diameter of about 5 mm over a tapering length of about 1.5 cm. Measurements are taken by forcing the tapered probe into kibble samples at a constant speed of about 2 mm/sec with a maximum travel distance of the tapered probe set to prevent the probe from contacting the substrate holding the kibble sample. The penetration force in Newtons (N) and the distance until breakage in millimeters (mm) is then recorded for each of the samples, and from this data, the stiffness is calculated in Newtons per millimeter (N/mm). The data collected using this process can delineate the rheology difference between dry kibble compared to semi-moist kibble. The data collected is provided in Table 5, as follows:

TABLE 5
Rheology Data

| Sample | Force (N) | Distance (mm) | Stiffness (N/mm) |
|---|---|---|---|
| Semi-moist Sample 1 | 26.9 | 3.4 | 12.6 |
| Dry Sample 1 | 69.5 | 1.7 | 65.7 |
| Dry Sample 2 | 112.0 | 2.3 | 91.0 |
| Dry Sample 3 | 82.97 | 1.4 | 90.4 |

As can be seen by Table 5, for kibble that is considered to be dry kibble in accordance with examples of the present disclosure, the stiffness is typically considerably greater than semi-moist kibble samples. The dry kibble ranged in stiffness from 65.7 N/mm to 91.0 N/mm. This same process can be used for kibble prepared in accordance with the present disclosure to determine the rheology of the kibble. Notably, this example provides non-limiting stiffness values, but in some instances, dry kibble that is slightly less moist may be expected to be somewhat stiffer, and dry kibble that is slightly moister may be expected to be somewhat less stiff, even if still considered to be “dry.” Stiffness may likewise vary depending on the formulation of the dry kibble. However, it is noted that even on the low end, e.g., 65.7 N/mm, the stiffness is almost 5 times greater in value than the stiffness of the semi-moist sample of the present example. Even at 40 N/mm for a sample of dry kibble, this would still be greater than 3 times stiffer in stiffness value compared to the semi-moist sample of this example.

In the specification, there have been disclosed certain embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims, the invention may be practiced otherwise than as specifically described.

What is claimed is:

1. A method of feeding a small adult dog, comprising dispensing a serving of dry kibble to a small adult dog weighing up to about 11 kg, wherein from about 20% to 100% of individual dry kibble pieces of the serving are donut-shaped having an average inner-hole diameter from about 3 mm to about 8 mm, wherein the individual dry kibble pieces of the serving are about 8 mm to about 2 cm in average diameter and about 8 mm to about 2 cm in average thickness.

2. The method of claim 1, wherein the average diameter is from about 1.1 cm to about 2 cm.

3. The method of claim 1, wherein the average diameter is from about 1.4 cm to about 2 cm.

4. The method of claim 1, wherein the average thickness is from about 1.1 cm to about 1.8 cm.

5. The method of claim 1, wherein the dry kibble has a moisture content from about 4 wt % to about 10 wt %.

6. The method of claim 1, wherein the dry kibble has a stiffness from about 40 N/mm to about 120 N/mm.

7. The method of claim 1, wherein after dispensing the serving and the small adult dog begins feeding on the dry kibble, from about 45% to about 75% of the first three minutes of feeding on average includes chew time.

8. The method of claim 1, wherein after dispensing the serving and the small adult dog begins feeding on the dry kibble, less than 50% of the first three minutes of feeding on average includes prehension time.

9. The method of claim 1, wherein the small adult dog exhibits a lower frequency of labored swallowing during the first three minutes of feeding the dry kibble to the small adult dog as compared to the first three minutes of feeding the small adult dog a comparative dry kibble without an inner-hole therethrough and having about a smaller diameter and a smaller thickness compared to the dry kibble.

10. The method of claim 1, wherein the small adult dog has an average oral cavity area from about 12 cm² to about 22 cm².

11. Dry kibble, comprising from about 20% to 100% donut-shaped dry kibble pieces having an average inner-hole diameter from about 3 mm to about 8 mm, wherein the individual dry kibble pieces of the serving are about 1.1 cm to about 2 cm in average diameter and about 8 mm to about 2 cm in average thickness, and wherein the dry kibble has a moisture content up to about 10 wt % and an average stiffness from about 40 N/mm to about 120 N/mm.

12. The dry kibble of claim 11, wherein the dry kibble is formulated for small adult dogs and is packaged with indicia indicating that the dry kibble is for small adult dogs.

13. The dry kibble of claim 11, wherein the average diameter is from about 1.4 cm to about 2 cm.

14. The dry kibble of claim 11, wherein the average thickness is from about 1.1 cm to about 2 cm.

15. The dry kibble of claim 11, wherein the individual dry kibble pieces of the serving are about 1.4 cm to about 2 cm in average diameter and about 1.1 cm to 1.8 cm in average thickness.
